(19) United States
(12) Patent Application Publication
(10) Pub. No.: US 2026/0303162 A1
(43) Pub. Date: Oct. 1, 2026

(54) BEAMSPACE RECIPROCITY BASED PRECODER FOR PDCCH USER SPECIFIC BEAMFORMING FALLBACK

(71) Applicant: Telefonaktiebolaget LM Ericsson (publ), Stockholm (SE)

(72) Inventors: Hamza SOKUN, Ottawa, CA (US); Amr EL-KEYI, Kanata (CA)

(73) Assignee: Telefonaktiebolaget LM Ericsson (publ), Stockholm (SE)

(21) Appl. No.: 19/479,352

(22) PCT Filed: May 2, 2023
(86) PCT No.: PCT/IB2023/054568

§ 371 Date: Oct. 28, 2025

(51) Int. Cl. H04B 7/06

(52) U.S. Cl. CPC H04B 7/0617; H04B 7/0626; H04B 7/063

(57) ABSTRACT

A method, system and apparatus are disclosed. A network node is provided which is configured to detect a first beamforming precoder failure associated with a first beamforming precoder used for at least one downlink transmission to a WD, responsive to detecting the first beamforming precoder failure, determine a first fallback beamforming configuration for the WD based on at least one of uplink reference signaling from the WD and a control channel element (CCE) aggregation level associated with the WD, configure the WD with the first fallback beamforming configuration, and transmit a first downlink transmission to the WD according to the first fallback beamforming configuration.

### TECHNICAL FIELD

The present disclosure relates to wireless communications, and in particular, to configurations for supporting beamspace reciprocity-based precoding for PDCCH user-specific beamforming fallback.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

In some 4G and 5G communication networks, the Physical Downlink Control Channel (PDCCH) carries Downlink Control Information (DCI) that is required to perform critical network functionalities such as downlink scheduling assignments, uplink scheduling grants and hybrid automatic repeat request (HARQ) feedback. Using User-specific BeamForming (UBF) has been considered for PDCCH transmission. Compared to user non-specific Common BeamForming (CBF), UBF may significantly increase the received signal power of PDCCH and enhance PDCCH capacity and coverage.

In some existing systems, the UBF downlink precoding matrix for PDCCH transmission may be selected using the reported Precoding Matrix Indicator (PMI) contained in the channel state information (CSI) feedback transmitted by the WD (User Equipment (UE)) to the network node (base station). The PMI may correspond to a specific precoder matrix which is selected by the WD from a given codebook based on, e.g., downlink measurements on the downlink Channel State Information Reference Symbols (CSI-RS). The performance gain of UBF over CBF may depend on the reliability and accuracy of the selected precoder. In practice, the reliability of the reported PMI often cannot be ensured due to several reasons, such as errors in the reported PMI due to poor WD detection of CSI-RS, errors in PMI decoding at the network node (base station) due to an unreliable uplink, or long CSI reporting duration which may cause the network node (base station) to use an outdated reported PMI. Using the wrong PDCCH UBF precoder may cause failure in decoding the PDCCH successfully, which may lead to increasing the number of Uplink (UL) and Downlink (DL) HARQ Discontinuous Transmission (DTX) events where the network node (base station) finds no HARQ information at the expected frequency resource, as well as increasing CSI DTX events corresponding to failures in receiving the next CSI reports. To improve the robustness of PMI-based PDCCH UBF, existing work has considered different versions of PDCCH precoder fallback algorithms for different severity levels of the wrong PDCCH UBF precoder issue in the network. For example, an algorithm in one example existing system does not directly fall back to CBF when the wrong PDCCH UBF precoder issue occurs for a cell edge WD, where PDCCH coverage is critical and PDCCH CBF does not work well. Instead, in this example, it may use the previous successful reported PMI first. If the previous successful reported PMI fails, then CBF may be used as a last resort.

Existing PDCCH beamforming fallback algorithms include using CBF when the wrong PDCCH UBF issue may be detected. However, this may lead to PDCCH Signal to Noise Ratio (SNR) loss as the beamforming gain of CBF may be lower than that of UBF. The SNR loss may be critical especially to cell-edge WDs, and may lead to PDCCH detection failure. To solve this problem, one example existing algorithm uses the reported PMI that resulted in the last successful PDCCH transmission, instead of falling back to CBF directly. However, there may be a high probability that this PMI may be already outdated, e.g., especially if the WD has high mobility and/or when the PMI reporting period is large.

Thus, existing systems may lack configurations for supporting beamforming fallback algorithms.

### SUMMARY

Some embodiments advantageously provide methods, systems, and apparatuses for supporting beamspace reciprocity-based precoding for PDCCH user-specific beamforming fallback.

In some embodiments, UL/DL channel reciprocity may be exploited to construct a PDCCH UBF fallback precoder, e.g., instead of relying on CBF or previous reported PMI only for precoder fall back. For example, a reciprocity based UBF precoder according to some embodiments described herein, as implemented by a network node and/or WD, for instance, may utilize the channel estimates obtained from uplink reference symbols to estimate the strongest two-directional (azimuth-elevation) spatial direction of the channel. This may be accomplished, e.g., by transforming the channel estimates to Beamspace, and computing the power in each Beamspace basis direction, i.e., spatial direction. The Beamspace power may be filtered over time and the azimuth and elevation directions corresponding to the spatial beam with the highest power are identified. A reciprocity-based UBF PDDCH precoder may be constructed by applying a cophasing factor to the combined azimuth-elevation spatial beam. The cophasing factor may be selected from a set of discrete factors and cophasing factor cycling can be utilized to provide additional robustness for PDCCH transmission when PDCCH repetition is employed. The Beamspace power per beam may also be used to compute the beamforming gain of the precoder to be used in PDCCH link adaptation and Control Channel Element (CCE) aggregation level selection.

A fallback algorithm according to some embodiments of the present disclosure may use one or more metrics to detect PDDCH precoder failure, e.g., the time since last successfully decoded CSI report, the number of CSI DTX events, and/or the number of consecutive UL (and/or DL) HARQ DTX events. When the wrong PDCCH precoder issue is detected, the fallback algorithm may switch between different types of precoding based on the CCE aggregation level. For the case of cell-edge WDs where significant gain in PDCCH capacity and coverage may be achieved, some embodiments may utilize a fallback algorithm which selects the proposed reciprocity based precoder before falling back to using CBF, e.g., if the wrong PDCCH precoder issue persists.

Embodiments of the present disclosure may provide one or more advantages over existing systems. For example, a reciprocity based PDCCH UBF precoder according to one or more embodiments described herein may provide significant SNR gain over CBF, which may improve the coverage and/or capacity for PDCCH. A reciprocity based PDCCH UBF precoder according to one or more embodiments described herein may provide improved robustness against WD mobility as compared to existing fallback techniques. Further, a reciprocity based PDCCH UBF precoder according to one or more embodiments described herein may support variable co-phasing factors with PDCCH repetition, which may improves the robustness of PDCCH transmission as compared to some existing systems. Moreover, variable co-phasing factors may be utilized for different Resource Element Group (REG)-bundles.

According to a first aspect of the present disclosure, a network node for supporting beamspace reciprocity-based precoding for PDCCH user-specific beamforming fallback is provided. The network node is configured to detect a first beamforming precoder failure associated with a first beamforming precoder used for at least one downlink transmission to the wireless device. The network node is configured to, responsive to detecting the first beamforming precoder failure, determine a first fallback beamforming configuration for the wireless device based on at least one of uplink reference signaling from the wireless device and a control channel element (CCE) aggregation level associated with the wireless device. The network node is configured to configure the wireless device with the first fallback beamforming configuration. The network node is configured to transmit (Block S140) a first downlink transmission to the wireless device according to the first fallback beamforming configuration.

According to one or more embodiments of this aspect, the determining of the first fallback beamforming configuration includes determining beam power information for a plurality of beams based on the uplink reference signaling, determining at least one strongest channel direction for the plurality of beams based on the beam power information, and determining a reciprocity-based precoder based on the at least one strongest channel direction.

According to one or more embodiments of this aspect, the reciprocity-based precoder is associated with a plurality of different co-phasing factors, each of the plurality of co-phasing factors being configured for a corresponding downlink transmission of a plurality of downlink transmissions to the WD which use the reciprocity-based precoder.

According to one or more embodiments of this aspect, the determining of the reciprocity-based precoder includes determining co-phase information for the at least one strongest channel direction using a co-phasing factor, the co-phasing factor being variable based on a downlink control channel repetition being configured.

According to one or more embodiments of this aspect, the determining of the beam power information for the plurality of beams based on the uplink reference signaling includes determining a polarization-averaged filtered power per beam of the plurality of beams.

According to one or more embodiments of this aspect, the network node is further configured to determine a beamforming gain of the reciprocity-based precoder based on the beam power information, determine a signal to interference and noise ratio (SINR) estimate for downlink control channel link adaptation based on the beamforming gain, and configure a control channel element (CCE) aggregation level for the first downlink transmission to the WD based on at least one of the beamforming gain and the SINR estimate.

According to one or more embodiments of this aspect, detecting the first beamforming precoder failure is based on at least one of an amount of time elapsed from a previously successfully decoded channel state information (CSI) report exceeding a first threshold, a number of CSI discontinuous transmission (DTX) events exceeding a second threshold, a number of consecutive uplink hybrid automatic repeat request (HARQ) DTX events exceeding a third threshold, and a number of consecutive downlink HARQ DTX events exceeding a fourth threshold.

According to one or more embodiments of this aspect, the first fallback beamforming configuration is one of a reciprocity-based precoder based on the CCE aggregation level being one, and a most-recent previous successful precoder associated with the WD based on the CCE aggregation level being greater than one.

According to one or more embodiments of this aspect, the network node is further configured to detect a second beamforming precoder failure associated with the first fallback beamforming configuration, responsive to detecting the second beamforming precoder failure, determine a second fallback beamforming configuration, the second fallback beamforming configuration being one of a most-recent previous successful precoder associated with the WD based on the CCE aggregation level being one, and a reciprocity-based precoder based on the CCE aggregation level being greater than one, configure the WD with the second fallback beamforming configuration, and transmit a second downlink transmission to the WD according to the second fallback beamforming configuration.

According to one or more embodiments of this aspect, the network node is further configured to detect a third beamforming precoder failure associated with the second fallback beamforming configuration, responsive to detecting the third beamforming precoder failure, configure the WD with a third fallback beamforming configuration based on a common beamforming precoder, and transmit a third downlink transmission to the WD according to a third fallback beamforming configuration.

According to another aspect of the present disclosure, a method implemented in a network node for supporting beamspace reciprocity-based precoding for PDCCH user-specific beamforming fallback is provided. The method includes detecting a first beamforming precoder failure associated with a first beamforming precoder used for at least one downlink transmission to the wireless device. The method includes, responsive to detecting the first beamforming precoder failure, determining a first fallback beamforming configuration for the wireless device based on at least one of uplink reference signaling from the wireless device and a control channel element (CCE) aggregation level associated with the wireless device. The method includes configuring the wireless device with the first fallback beamforming configuration. The method includes transmitting a first downlink transmission to the wireless device according to the first fallback beamforming configuration.

According to one or more embodiments of this aspect, the determining of the first fallback beamforming configuration includes determining beam power information for a plurality of beams based on the uplink reference signaling, determining at least one strongest channel direction for the plurality of beams based on the beam power information, and determining a reciprocity-based precoder based on the at least one strongest channel direction.

According to one or more embodiments of this aspect, the reciprocity-based precoder is associated with a plurality of different co-phasing factors, each of the plurality of co-phasing factors being configured for a corresponding downlink transmission of a plurality of downlink transmissions to the WD which use the reciprocity-based precoder.

According to one or more embodiments of this aspect, the determining of the reciprocity-based precoder includes determining co-phase information for the at least one strongest channel direction using a co-phasing factor, the co-phasing factor being variable based on a downlink control channel repetition being configured.

According to one or more embodiments of this aspect, the determining of the beam power information for the plurality of beams based on the uplink reference signaling includes determining a polarization-averaged filtered power per beam of the plurality of beams.

According to one or more embodiments of this aspect, the method further includes determining a beamforming gain of the reciprocity-based precoder based on the beam power information, determining a signal to interference and noise ratio (SINR) estimate for downlink control channel link adaptation based on the beamforming gain, and configuring a control channel element (CCE) aggregation level for the first downlink transmission to the WD based on at least one of the beamforming gain and the SINR estimate.

According to one or more embodiments of this aspect, detecting the first beamforming precoder failure is based on at least one of an amount of time elapsed from a previously successfully decoded channel state information (CSI) report exceeding a first threshold, a number of CSI discontinuous transmission (DTX) events exceeding a second threshold, a number of consecutive uplink hybrid automatic repeat request (HARQ) DTX events exceeding a third threshold, and a number of consecutive downlink HARQ DTX events exceeding a fourth threshold.

According to one or more embodiments of this aspect, the first fallback beamforming configuration is one of a reciprocity-based precoder based on the CCE aggregation level being one, and a most-recent previous successful precoder associated with the WD based on the CCE aggregation level being greater than one.

According to one or more embodiments of this aspect, the method further includes detecting a second beamforming precoder failure associated with the first fallback beamforming configuration, responsive to detecting the second beamforming precoder failure, determining a second fallback beamforming configuration, the second fallback beamforming configuration being one of a most-recent previous successful precoder associated with the WD based on the CCE aggregation level being one, and a reciprocity-based precoder based on the CCE aggregation level being greater than one, configuring the WD with the second fallback beamforming configuration, and transmitting a second downlink transmission to the WD according to the second fallback beamforming configuration.

According to one or more embodiments of this aspect, the method further includes detecting a third beamforming precoder failure associated with the second fallback beamforming configuration, responsive to detecting the third beamforming precoder failure, configuring the WD with a third fallback beamforming configuration based on a common beamforming precoder, and transmitting a third downlink transmission to the WD according to a third fallback beamforming configuration.

According to another aspect of the present disclosure, a wireless device for supporting beamspace reciprocity-based precoding for PDCCH user-specific beamforming fallback is provided. The wireless device (WD) is configured to transmit a first uplink transmission to a network node, the first uplink transmission enabling the network node to detect a first beamforming precoder failure associated with a first beamforming precoder used for at least one downlink transmission to the WD. The WD is configured to, responsive to the first uplink transmission, receive a first fallback beamforming configuration from the network node, the first fallback beamforming configuration being based on at least one of uplink reference signaling transmitted to the network node and a control channel element (CCE) aggregation level associated with the WD. The WD is configured to receive a first downlink transmission from the network node. The WD is configured to process the first downlink transmission according to the first fallback beamforming configuration.

According to one or more embodiments of this aspect, the first fallback beamforming configuration includes a reciprocity-based precoder, the reciprocity-based precoder being selected based on beam power information for a plurality of beams associated with the uplink reference signaling, the beam power information including at least one strongest channel direction for the plurality of beams.

According to one or more embodiments of this aspect, the reciprocity-based precoder is associated with a plurality of different co-phasing factors, each of the plurality of co-phasing factors being configured for a corresponding downlink transmission of a plurality of downlink transmissions to the WD which use the reciprocity-based precoder.

According to one or more embodiments of this aspect, the reciprocity-based precoder is associated with co-phase information for the at least one strongest channel direction, the co-phase information including at least one co-phasing factor, the at least one co-phasing factor being variable based on a downlink control channel repetition being configured.

According to one or more embodiments of this aspect, the beam power information for the plurality of beams is associated with a polarization-averaged filtered power per beam of the plurality of beams.

According to one or more embodiments of this aspect, the first beamforming precoder failure is associated with at least one of an amount of time elapsed from a previously successfully decoded channel state information (CSI) report exceeding a first threshold, a number of CSI discontinuous transmission (DTX) events exceeding a second threshold, a number of consecutive uplink hybrid automatic repeat request (HARQ) DTX events exceeding a third threshold, and a number of consecutive downlink HARQ DTX events exceeding a fourth threshold.

According to one or more embodiments of this aspect, the first fallback beamforming configuration is one of a reciprocity-based precoder based on the CCE aggregation level being one, and a most-recent previous successful precoder associated with the WD based on the CCE aggregation level being greater than one.

According to one or more embodiments of this aspect, the WD is further configured to transmit a second uplink transmission to the network node, the second uplink transmission enabling the network node to detect a second beamforming precoder failure associated with the first fallback beamforming configuration, responsive to the detecting of the second beamforming precoder failure, receive a second fallback beamforming configuration from the network node, the second fallback beamforming configuration being one of a most-recent previous successful precoder associated with the WD based on the CCE aggregation level being one, and a reciprocity-based precoder based on the CCE aggregation level being greater than one, receive a second downlink transmission from the network node, and process the second downlink transmission according to the second fallback beamforming configuration.

According to one or more embodiments of this aspect, the WD is further configured to transmit a third uplink transmission to the network node, the third uplink transmission enabling the network node to detect a third beamforming precoder failure associated with the second fallback beamforming configuration, receive a third fallback beamforming configuration from the network node, the third fallback beamforming configuration configuring beamforming based on a common beamforming precoder, responsive to detecting the third beamforming precoder failure, receive a third downlink transmission from the network node, and process the third downlink transmission according to the third fallback beamforming configuration.

According to another aspect of the present disclosure, a method in a wireless device for supporting beamspace reciprocity-based precoding for PDCCH user-specific beamforming fallback is provided. The method includes transmitting a first uplink transmission to a network node, the first uplink transmission enabling the network node to detect a first beamforming precoder failure associated with a first beamforming precoder used for at least one downlink transmission to the WD. The method includes, responsive to the first uplink transmission, receiving a first fallback beamforming configuration from the network node, the first fallback beamforming configuration being based on at least one of uplink reference signaling transmitted to the network node and a control channel element (CCE) aggregation level associated with the WD. The method includes receiving a first downlink transmission from the network node. The method includes processing the first downlink transmission according to the first fallback beamforming configuration.

According to one or more embodiments of this aspect, the first fallback beamforming configuration includes a reciprocity-based precoder, the reciprocity-based precoder being selected based on beam power information for a plurality of beams associated with the uplink reference signaling, the beam power information including at least one strongest channel direction for the plurality of beams.

According to one or more embodiments of this aspect, the reciprocity-based precoder is associated with a plurality of different co-phasing factors, each of the plurality of co-phasing factors being configured for a corresponding downlink transmission of a plurality of downlink transmissions to the WD which use the reciprocity-based precoder.

According to one or more embodiments of this aspect, the reciprocity-based precoder is associated with co-phase information for the at least one strongest channel direction, the co-phase information including at least one co-phasing factor, the at least one co-phasing factor being variable based on a downlink control channel repetition being configured.

According to one or more embodiments of this aspect, the beam power information for the plurality of beams is associated with a polarization-averaged filtered power per beam of the plurality of beams.

According to one or more embodiments of this aspect, the first beamforming precoder failure is associated with at least one of an amount of time elapsed from a previously successfully decoded channel state information (CSI) report exceeding a first threshold, a number of CSI discontinuous transmission (DTX) events exceeding a second threshold, a number of consecutive uplink hybrid automatic repeat request (HARQ) DTX events exceeding a third threshold, and a number of consecutive downlink HARQ DTX events exceeding a fourth threshold.

According to one or more embodiments of this aspect, the first fallback beamforming configuration is one of a reciprocity-based precoder based on the CCE aggregation level being one, and a most-recent previous successful precoder associated with the WD based on the CCE aggregation level being greater than one.

According to one or more embodiments of this aspect, the method further includes transmitting a second uplink transmission to the network node, the second uplink transmission enabling the network node to detect a second beamforming precoder failure associated with the first fallback beamforming configuration, responsive to the detecting of the second beamforming precoder failure, receiving a second fallback beamforming configuration from the network node, the second fallback beamforming configuration being one of a most-recent previous successful precoder associated with the WD based on the CCE aggregation level being one, and a reciprocity-based precoder based on the CCE aggregation level being greater than one, receiving a second downlink transmission from the network node, and processing the second downlink transmission according to the second fallback beamforming configuration.

According to one or more embodiments of this aspect, the method further includes transmitting a third uplink transmission to the network node, the third uplink transmission enabling the network node to detect a third beamforming precoder failure associated with the second fallback beamforming configuration, receiving a third fallback beamforming configuration from the network node, the third fallback beamforming configuration configuring beamforming based on a common beamforming precoder, responsive to detecting the third beamforming precoder failure, receiving a third downlink transmission from the network node, and processing the third downlink transmission according to the third fallback beamforming configuration.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node for supporting beamspace reciprocity-based precoding for PDCCH user-specific beamforming fallback according to some embodiments of the present disclosure;

FIG. 8 is a flowchart of an example process in a wireless device for supporting beamspace reciprocity-based precoding for PDCCH user-specific beamforming fallback according to some embodiments of the present disclosure;

FIG. 9 is a flowchart of another example process in a wireless device and/or a network node for supporting beamspace reciprocity-based precoding for PDCCH user-specific beamforming fallback according to some embodiments of the present disclosure;

FIG. 10 is a flowchart of another example process in a wireless device and/or a network node for supporting beamspace reciprocity-based precoding for PDCCH user-specific beamforming fallback according to some embodiments of the present disclosure; and

FIG. 11 is a flowchart of another example process in a wireless device and/or a network node for supporting beamspace reciprocity-based precoding for PDCCH user-specific beamforming fallback according to some embodiments of the present disclosure.

### DETAILED DESCRIPTION

Before describing in detail example embodiments, it is noted that the embodiments reside primarily in combinations of apparatus components and processing steps related to configurations for supporting beamspace reciprocity-based precoding for PDCCH user-specific beamforming fallback. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MIDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations and methods for supporting beamspace reciprocity-based precoding for PDCCH user-specific beamforming fallback.

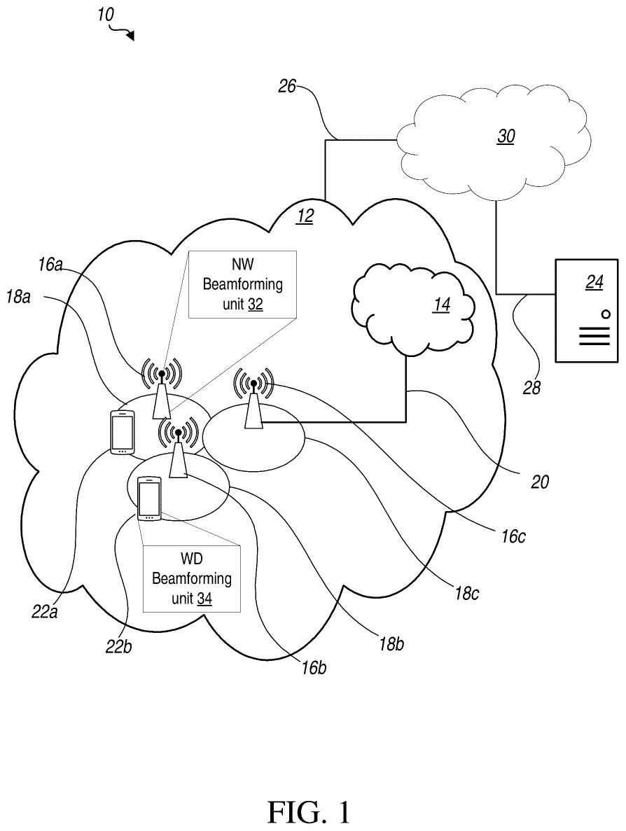

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NW Beamforming unit 32 which is configured for supporting beamspace reciprocity-based precoding for PDCCH user-specific beamforming fallback. A wireless device 22 is configured to include a WD Beamforming unit 34 which is configured for supporting beamspace reciprocity-based precoding for PDCCH user-specific beamforming fallback.

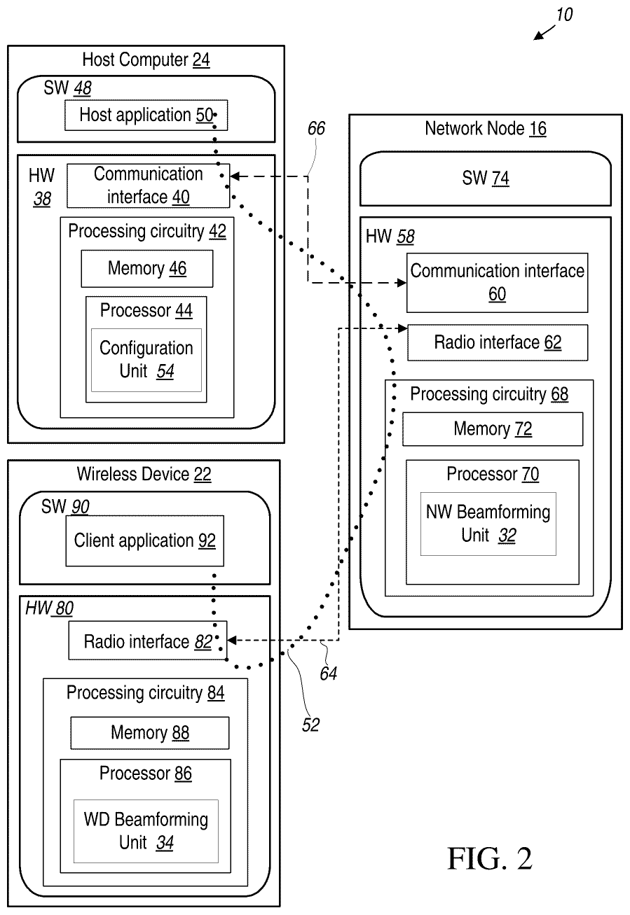

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Configurations unit 54 configured to enable the service provider to observe/monitor/control/transmit to/receive from/etc. the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NW Beamforming unit 32 configured for supporting beamspace reciprocity-based precoding for PDCCH user-specific beamforming fallback.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD Beamforming unit 34 configured for supporting beamspace reciprocity-based precoding for PDCCH user-specific beamforming fallback.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as NW Beamforming unit 32, and WD Beamforming unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

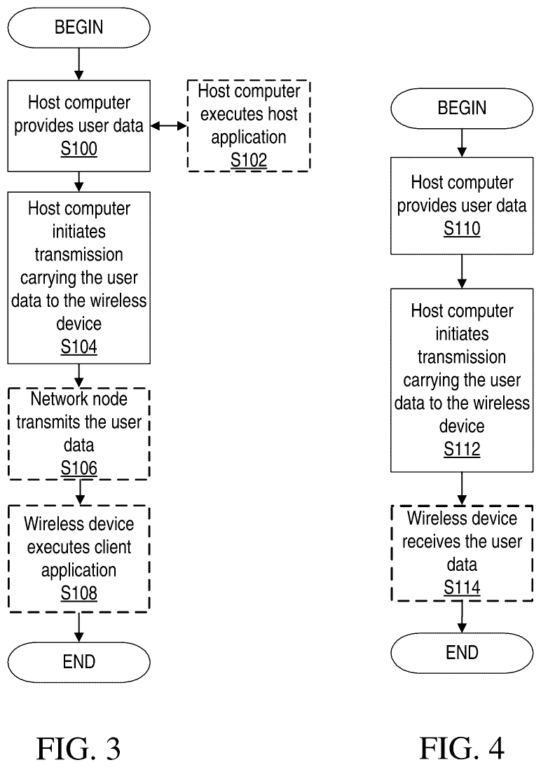

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

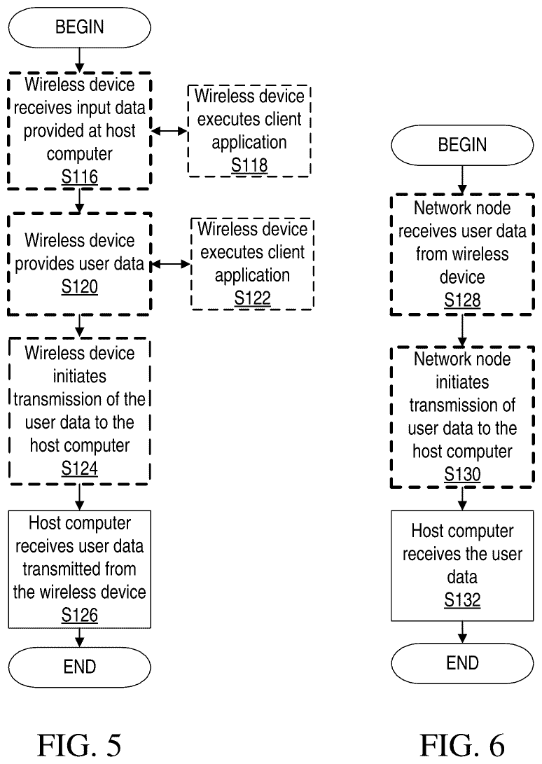

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

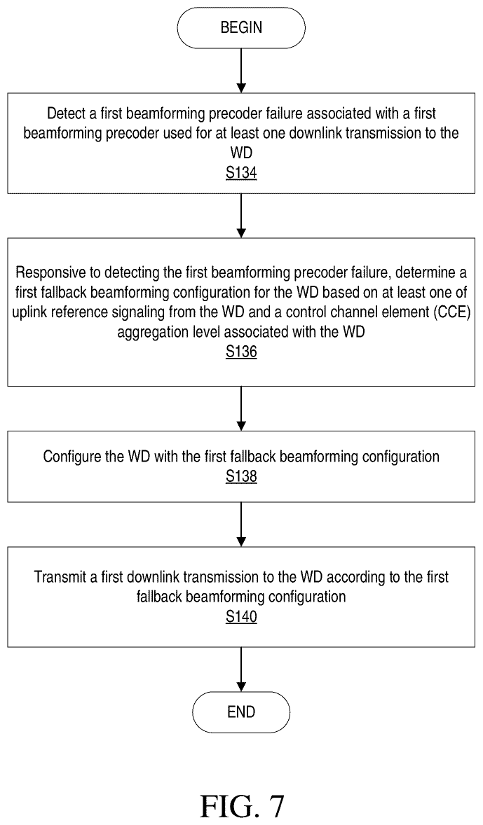

FIG. 7 is a flowchart of an example process in a network node 16 for supporting beamspace reciprocity-based precoding for PDCCH user-specific beamforming fallback. One or more blocks described herein may be performed by one or more elements of network node 16 such as by one or more of processing circuitry 68 (including the NW Beamforming unit 32), processor 70, radio interface 62 and/or communication interface 60. Network node 16 is configured to detect (Block S134) a first beamforming precoder failure associated with a first beamforming precoder used for at least one downlink transmission to the wireless device. Network node 16 is configured to, responsive to detecting the first beamforming precoder failure, determine (Block S136) a first fallback beamforming configuration for the wireless device 22 based on at least one of uplink reference signaling from the wireless device 22 and a control channel element (CCE) aggregation level associated with the wireless device. Network node 16 is configured to configure (Block S138) the wireless device with the first fallback beamforming configuration. Network node 16 is configured to transmit (Block S140) a first downlink transmission to the wireless device 22 according to the first fallback beamforming configuration.

In some embodiments, the determining of the first fallback beamforming configuration includes determining beam power information for a plurality of beams based on the uplink reference signaling, determining at least one strongest channel direction for the plurality of beams based on the beam power information, and determining a reciprocity-based precoder based on the at least one strongest channel direction.

In some embodiments, the reciprocity-based precoder is associated with a plurality of different co-phasing factors, each of the plurality of co-phasing factors being configured for a corresponding downlink transmission of a plurality of downlink transmissions to the WD 22 which use the reciprocity-based precoder.

In some embodiments, the determining of the reciprocity-based precoder includes determining co-phase information for the at least one strongest channel direction using a co-phasing factor, the co-phasing factor being variable based on a downlink control channel repetition being configured.

In some embodiments, the determining of the beam power information for the plurality of beams based on the uplink reference signaling includes determining a polarization-averaged filtered power per beam of the plurality of beams.

In some embodiments, the network node 16 is further configured to determine a beamforming gain of the reciprocity-based precoder based on the beam power information, determine a signal to interference and noise ratio (SINR) estimate for downlink control channel link adaptation based on the beamforming gain, and configure a control channel element (CCE) aggregation level for the first downlink transmission to the WD 22 based on at least one of the beamforming gain and the SINR estimate.

In some embodiments, detecting the first beamforming precoder failure is based on at least one of an amount of time elapsed from a previously successfully decoded channel state information (CSI) report exceeding a first threshold, a number of CSI discontinuous transmission (DTX) events exceeding a second threshold, a number of consecutive uplink hybrid automatic repeat request (HARQ) DTX events exceeding a third threshold, and a number of consecutive downlink HARQ DTX events exceeding a fourth threshold.

In some embodiments, the first fallback beamforming configuration is one of a reciprocity-based precoder based on the CCE aggregation level being one, and a most-recent previous successful precoder associated with the WD 22 based on the CCE aggregation level being greater than one.

In some embodiments, the network node 16 is further configured to detect a second beamforming precoder failure associated with the first fallback beamforming configuration, responsive to detecting the second beamforming precoder failure, determine a second fallback beamforming configuration, the second fallback beamforming configuration being one of a most-recent previous successful precoder associated with the WD 22 based on the CCE aggregation level being one, and a reciprocity-based precoder based on the CCE aggregation level being greater than one, configure the WD 22 with the second fallback beamforming configuration, and transmit a second downlink transmission to the WD 22 according to the second fallback beamforming configuration.

In some embodiments, the network node 16 is further configured to detect a third beamforming precoder failure associated with the second fallback beamforming configuration, responsive to detecting the third beamforming precoder failure, configure the WD 22 with a third fallback beamforming configuration based on a common beamforming precoder, and transmit a third downlink transmission to the WD 22 according to a third fallback beamforming configuration.

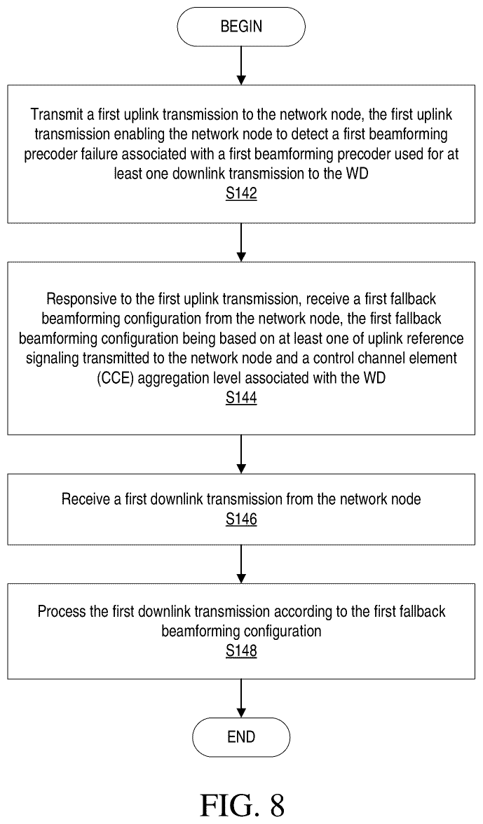

FIG. 8 is a flowchart of an example process in a wireless device 22 according to some embodiments of the present disclosure for supporting beamspace reciprocity-based precoding for PDCCH user-specific beamforming fallback. One or more blocks described herein may be performed by one or more elements of wireless device 22 such as by one or more of processing circuitry 84 (including the WD Beamforming unit 34), processor 86, radio interface 82 and/or communication interface 60. Wireless device (WD) 22 is configured to transmit (Block S142) a first uplink transmission to the network node 16, the first uplink transmission enabling the network node 16 to detect a first beamforming precoder failure associated with a first beamforming precoder used for at least one downlink transmission to the WD 22. WD 22 is configured to, responsive to the first uplink transmission, receive (Block S144) a first fallback beamforming configuration from the network node 16, the first fallback beamforming configuration being based on at least one of uplink reference signaling transmitted to the network node 16 and a control channel element (CCE) aggregation level associated with the WD 22. WD 22 is configured to receive (Block S146) a first downlink transmission from the network node 16. WD 22 is configured to process (Block S148) the first downlink transmission according to the first fallback beamforming configuration.

In some embodiments, the first fallback beamforming configuration includes a reciprocity-based precoder, the reciprocity-based precoder being selected based on beam power information for a plurality of beams associated with the uplink reference signaling, the beam power information including at least one strongest channel direction for the plurality of beams.

In some embodiments, the reciprocity-based precoder is associated with a plurality of different co-phasing factors, each of the plurality of co-phasing factors being configured for a corresponding downlink transmission of a plurality of downlink transmissions to the WD 22 which use the reciprocity-based precoder.

In some embodiments, the reciprocity-based precoder is associated with co-phase information for the at least one strongest channel direction, the co-phase information including at least one co-phasing factor, the at least one co-phasing factor being variable based on a downlink control channel repetition being configured.

In some embodiments, the beam power information for the plurality of beams is associated with a polarization-averaged filtered power per beam of the plurality of beams.

In some embodiments, the first beamforming precoder failure is associated with at least one of an amount of time elapsed from a previously successfully decoded channel state information (CSI) report exceeding a first threshold, a number of CSI discontinuous transmission (DTX) events exceeding a second threshold, a number of consecutive uplink hybrid automatic repeat request (HARQ) DTX events exceeding a third threshold, and a number of consecutive downlink HARQ DTX events exceeding a fourth threshold.

In some embodiments, the first fallback beamforming configuration is one of a reciprocity-based precoder based on the CCE aggregation level being one, and a most-recent previous successful precoder associated with the WD 22 based on the CCE aggregation level being greater than one.

In some embodiments, the WD 22 is further configured to transmit a second uplink transmission to the network node 16, the second uplink transmission enabling the network node 16 to detect a second beamforming precoder failure associated with the first fallback beamforming configuration, responsive to the detecting of the second beamforming precoder failure, receive a second fallback beamforming configuration from the network node 16, the second fallback beamforming configuration being one of a most-recent previous successful precoder associated with the WD 22 based on the CCE aggregation level being one, and a reciprocity-based precoder based on the CCE aggregation level being greater than one, receive a second downlink transmission from the network node 16, and process the second downlink transmission according to the second fallback beamforming configuration.

In some embodiments, the WD 22 is further configured to transmit a third uplink transmission to the network node 16, the third uplink transmission enabling the network node 16 to detect a third beamforming precoder failure associated with the second fallback beamforming configuration, receive a third fallback beamforming configuration from the network node 16, the third fallback beamforming configuration configuring beamforming based on a common beamforming precoder, responsive to detecting the third beamforming precoder failure, receive a third downlink transmission from the network node 16, and process the third downlink transmission according to the third fallback beamforming configuration.

Having described the general process flow of arrangements of the disclosure and having provided examples of hardware and software arrangements for implementing the processes and functions of the disclosure, the sections below provide details and examples of arrangements for supporting beamspace reciprocity-based precoding for PDCCH user-specific beamforming fallback.

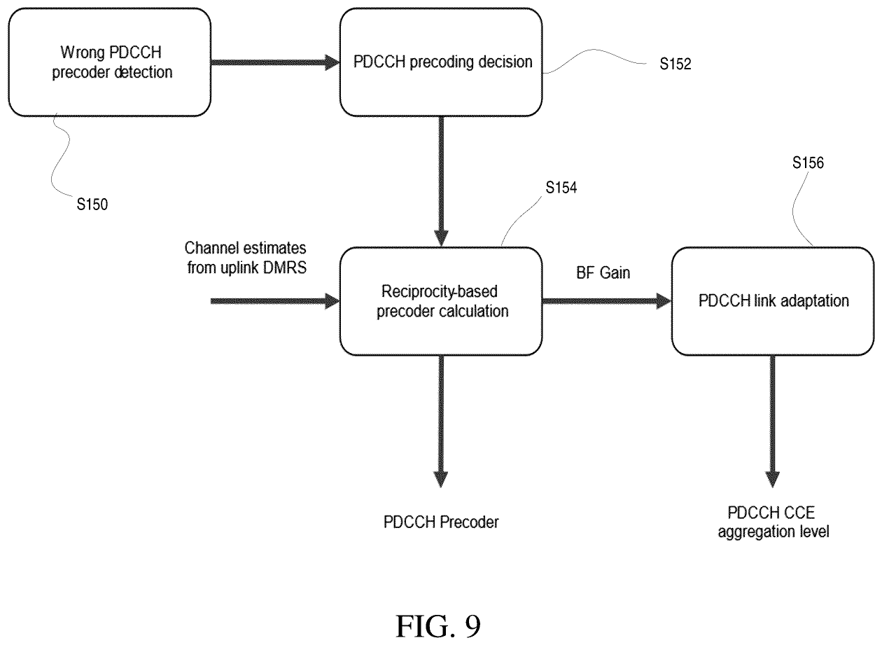

FIG. 9 shows a process flow block diagram for some embodiments of the present disclosure for a PDCCH precoder fallback mechanism. The network node 16 and/or WD 22 performs a detection of whether the PMI precoder used for PDCCH UBF is wrong (Step S150). If the wrong PMI issue is detected, the PDCCH precoder type may be selected (Step S152) (e.g., by network node 16 and/or WD 22) from different options, including, e.g., a Beamspace reciprocity based UBF precoder, a PMI precoder, or a CBF precoder. Embodiments of the present disclosure may include, for example, determining (e.g., by network node 16 and/or WD 22) a reciprocity-based UBF precoder using the uplink channel estimates from uplink reference symbols (Step S154), where the channel estimates may be transformed to a Beamspace domain, and the power per beam may be calculated (e.g., by network node 16 and/or WD 22) and used to identify the strongest channel directions and construct the PDCCH precoder. The power per beam may also be used (e.g., by network node 16 and/or WD 22) to compute the beamforming gain of the precoder to be used in PDCCH link adaptation (Step S156).

Detecting whether PDCCH is using a “wrong” precoder may be performed, e.g., according to one or more metrics which may indicate whether PDCCH UBF is problematic. These metrics include, for example, one or more of:
1. Time since last successfully decoded CSI report.
   a. In some embodiments, the thresholds for different metrics may be chosen adaptively, e.g., according to one or more of the following: 1) cell traffic load, 2) duplexing mode, i.e., TDD or FDD, 3) TDD pattern, and/or 4) number of component carriers.
2-Number of CSI DTX events.
3-Number of consecutive UL (and/or DL) HARQ DTX events.

If any of the above metrics exceeds its predefined threshold, for example, then a wrong PDCCH UBF precoder′ event may be declared/detected, and one or more PDCCH precoder fallback algorithms may be activated.

### PDCCH Precoding Decisions

When the ‘wrong PDCCH precoder’ event is detected (e.g., by network node 16 and/or WD 22), embodiments of the present disclosure may include, e.g., switching between different types of precoding procedures, e.g., according to the following example priority levels (other example priorities may be configured):
1-Beamspace Reciprocity-based UBF beamforming;
2-PMI-based precoding using the last PMI precoder(s) that resulted in successful PDCCH reception; and
3-WD 22-independent (UE independent) CBF.

In some embodiments, a different priority level may be configured than described above, e.g., depending on how much trust/credibility/accuracy may be assigned to the previous successful CSI report, such as, e.g.:
1-PMI-based precoding using the last PMI precoder(s) that resulted in successful PDCCH reception;
2-Beamspace Reciprocity-based UBF beamforming; and
3-WD 22 independent (UE independent) CBF.

In some embodiments, a precoding decision (e.g., by network node 16 and/or WD 22) may also be based on a PDCCH Control Channel Element (CCE) aggregation level configuration. For example, in some embodiments, when the CCE aggregation level is 1 before PDCCH LA factors in the extra gain coming from PDCCH UBF, the WD 22 may be presumed (e.g., by network node 16) to be experiencing good radio conditions, which may imply that there is no need to resort to UBF, e.g., as CBF can provide sufficient Signal to Interference-plus-Noise Ratio (SINR) to enable correct detection of the PDCCH. In some embodiments, when the CCE aggregation level is higher than 1, the PDCCH precoding may be switched according to one of the above precoding type priority levels, for example, or according to another priority level ordering, as configured. If the ‘wrong precoder’ issue still persists after switching, the network node 16 (and/or WD 22) may be configured to fall back to the next precoding scheme according to the above priority level.

Beamspace reciprocity-based User-Specific Beamforming

For example, in some embodiments, a network node 16 (e.g., base station) may be configured for employing an M-element 2-dimensional polarized array as shown in the equation below. My and My may be used to denote the number of rows and columns of the 2-dimensional antenna array, respectively, i.e., the total number of antenna elements is given by M=2M_{V}M_{H}. The M×1 vector hᵢ(f, t) containing the coefficients of the uplink channel from one of the transmission ports of the WD 22 to the network node 16 (base station) at time instant t and frequency subband f may be defined as

$$h ( f , t ) = {[ {h}^{{( 0 )}^{T}} ( f , t ) , {h}^{{( 1 )}^{T}} ( f , t ) ]}^{T}$$

where (.)^{T}, (.)^{H}, and (.)* denote the transpose, Hermitian transpose, and complex conjugate operators, respectively, and h^{(p)}(f, t) is the M_{V}M_{H}×1 vector containing the coefficients of the channel associated with the base station antennas with polarization p. For example, the channel estimates may be available at the network node 16 (e.g., base station) using the uplink reference signals transmitted from the WDs 22 during their uplink transmissions, e.g., from demodulation reference symbols (DMRS) associated with physical uplink shared channel (PUSCH) transmissions.

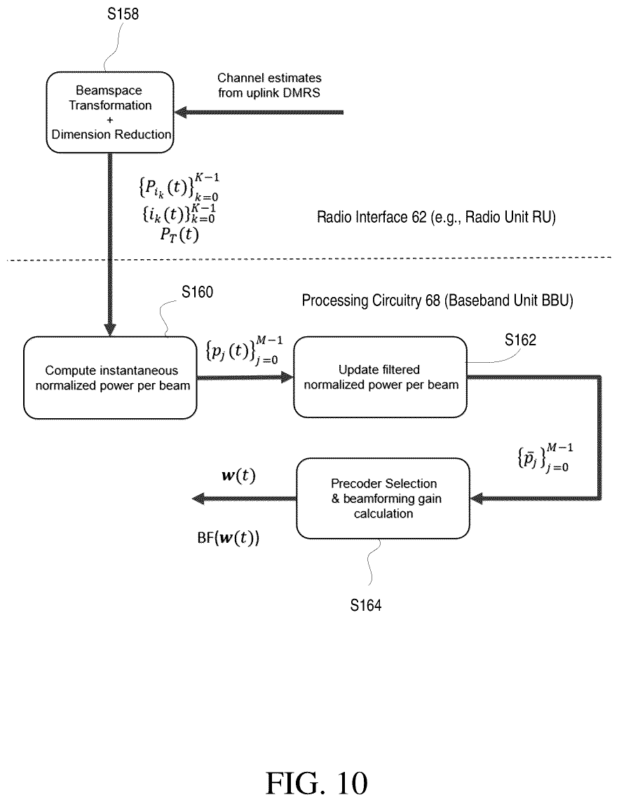

FIG. 10 shows a block diagram and process flow for a precoder selection algorithm for Beamspace reciprocity based UBF, e.g., in a network node 16 and/or WDD 22, according to some embodiments. A beamspace transformation and dimension reduction is performed (Step S158). The algorithm may utilize channel estimates from PUSCH DMRS to compute (Step S160) the instantaneous power per beam measurements for K<M beams together with the indices of these beams. In addition, the total power of the beams, P_{T}(t), may be computed. In some embodiments, computations may typically performed in the Radio Unit (RU) (e.g., radio interface 62) and transferred to the Baseband Unit (BBU) (e.g., processing circuitry 68) for processing where the instantaneous normalized power per beam is computed (Step S162) and the filtered normalized power per beam may be updated and used (e.g., by network node 16 and/or WD 22) to select the UBF precoder and compute the corresponding beamforming gain (Step S164).

In some embodiments, the RU and BBU may be implemented in the radio interface 62 and processing circuitry 68, respectively, but other arrangements and/or circuitry may be used to perform these functions without deviating from the scope of the present disclosure. For example, either one of radio interface 62 or processing circuitry 68 may implement both RU and BBU functionality, e.g., on one or more integrated circuits or other hardware. In some embodiments, the RU and BBU may be implemented on the same or separate network nodes 16, in the same or separate hardware/housing, etc.

Further, in some embodiments, the precoding may be performed for beamforming of downlink signaling, but embodiments of the present disclosure are not limited to beamforming of downlink signaling, and may be applied on uplink, sidelink, etc.

### Beamspace Transformation and Dimension Reduction

Massive MIMO channels are typically expected to have low rank, as communication typically occurs in a low-dimensional subspace of the high-dimensional spatial signal space. Beamspace transformation may be utilized to exploit the reduced rank of the signal subspace, e.g., where a subset of orthogonal beams is used to approximate the channel vectors. As a result, Beamspace transformation of channel estimates may reduce the number of significant elements of the channel vector, and hence, reduce the complexity of subsequent signal processing operations.

Two-Dimensional Spatial Discrete Fourier Transform (2D-SDFT) Beamspace basis may be used for 2-dimensional polarized arrays, as they match the spatial signature of propagating plane waves. For the 2-dimensional polarized array, the M×M matrix containing the basis of the 2D-SDFT Beamspace transformation may be given by:

$$B = {I}_{2} ⊗ {B}_{H} ⊗ {B}_{V}$$

where I_{K} denotes the K×K identity matrix, ⊗ denotes the Kronecker product operator, and B_{H} and B_{V} are M_{H}×M_{H} and M_{V}×M_{V} DFT matrices, i.e., the (m, k) element of B_{X} is given by

$$\frac{1}{\sqrt{{M}_{X}}} {e}^{j \frac{2 π mk}{{M}_{X}}}$$

where m, k=1, . . . , M_{X}.

The channel measurements may be converted to Beamspace using the transformation matrix B and dimension reduction may be applied (e.g., by network node 16 and/or WD 22). Several criteria may be used for selection of active beams used in dimension reduction of the WD 22 channel. The selection criteria may be based on the channel power where the instantaneous power per beam for the WD 22 may be computed from the channel estimates, e.g.,

$${P}_{b} ( t ) = {\sum }_{f} {\vert {[ {B}^{H} h ( f , t ) ]}_{b} \vert}^{2}$$

where |.| denotes the magnitude of a complex number, [x]_{b} denotes the bth component of the vector x and the summation is over the subbands for which channel estimates are available for the WD 22 at time t.

In order to reduce the communication rate between the RU (e.g., radio interface 62) and BBU (e.g., processing circuitry 68), typically a subset of instantaneous power per beam measurements,

$${\{ {P}_{{i}_{k}} ( t ) \}}_{k = 0}^{K - 1} ,$$

for K<M beams may be transmitted from the RU to the BBU together with the indices,

$${\{ {i}_{k} ( t ) \}}_{k = 0}^{K - 1} ,$$

of these beams for each PUSCH reception. In addition, the total power per beam P_{T}(t)=Σ_{b}P_{b}(t) may be transmitted from the RU to BBU. For example, A (t) may be used to denote the set containing the active beams for the WD 22 whose information will be transmitted from the RU to the BBU. In some embodiments, the active beams may be selected using any of the following methods, for example:

### 1-Fixed Number of Active Beams Method:

Network node 16 (and/or WD 22) may select a fixed number of beams that yield the maximum power sum Σ_{b∈A(t)}P_{b}(t).

### 2-Collected Power in Active Beams Method

In this method, network node 16 and/or WD 22 may select the minimum number of beams that have a total power greater than a fraction K of the total power in all beams, i.e., the set of active beams may be the solution to the following optimization problem:

$$min \vert A ( t ) \vert subject to {\sum }_{b ∈ A ( t )} {P}_{b} ( t ) > κ {\sum }_{b} {P}_{b} ( t ) .$$

where |A(t)| denotes the cardinality of the set A(t).

### 3-Threshold Based Beam Activation Method

In this method, network node 16 and/or WD 22 may select the beams that have a power value greater than a threshold t of the total power, i.e., the set of selected active beams is given by

$$A ( t ) = \{ b \vert {P}_{b} ( t ) > τ {\sum }_{b} {P}_{b} ( t ) \}$$

### Normalized Power Per Beam Calculation

The instantaneous power per beam measurements for K<M beams,

$${\{ {P}_{{i}_{k}} ( t ) \}}_{k = 0}^{K - 1} ,$$

together with the indices of these beams,

$${\{ {i}_{k} ( t ) \}}_{k = 0}^{K - 1}$$

and the total power P_{T}(t) in all beams may be available at the BBU (e.g., processing circuitry 68). These measurements may be used (e.g., by network node 16 and/or WD 22) to calculate the instantaneous normalized power per Beam at time t, p_{b}(t), for the K strongest beams as follows

$${p}_{{i}_{k}} ( t ) = \frac{{P}_{{i}_{k}} ( t )}{{P}_{T} ( t )} for k = 0 , … , K - 1.$$

The instantaneous normalized power per beam in each of the remaining M-4 beams may be assumed equal and may be computed (e.g., by network node 16 and/or WD 22) as

$${p}_{j} ( t ) = \frac{1 - {\sum }_{k = 0}^{K} {p}_{{i}_{k}} ( t )}{M - K} for j ∉ {\{ {i}_{k} ( t ) \}}_{k = 0}^{K - 1}$$

The filtered normalized power per beam, p̅ⱼ, may be updated (e.g., by network node 16 and/or WD 22) for all M beams using the instantaneous normalized power per beam

$${\overline{p}}_{j} = β {\overline{p}}_{j} + ( 1 - β ) {p}_{j} ( t )$$

where

$$β = {e}^{- \frac{Δ t}{{τ}_{B}}} ,$$

Δt is the time since the last filtered power per beam update and τ_{B} is the effective memory of the filter, i.e., the time constant of exponential filter.
Beam Power based Precoder Selection

The filtered power per beam, p̅ⱼ, may be utilized (e.g., by network node 16 and/or WD 22) to select the downlink precoder to be used in PDCCH UBF. The polarization-averaged filtered power per beam may first be computed (e.g., by network node 16 and/or WD 22) by averaging

$${\{ {\overline{p}}_{j} \}}_{j = 0}^{M - 1}$$

over the two polarizations, i.e.,

$${\overline{p}}_{j , av} = \frac{1}{2} ( {\overline{p}}_{j} + {\overline{p}}_{j + \frac{M}{2}} ) for j = 0 , … , \frac{M}{2} - 1$$

Let iₘₐₓ denote the beam index corresponding to the index with largest polarization-averaged filtered power per beam

$${i}_{max} = {argmax}_{j = 0 , … , \frac{M}{2} - 1} {\overline{p}}_{j , av}$$

Using the structure of the beamspace transformation matrix, B=I₂⊗D_{H}⊗D_{V}, the beam index iₘₐₓ may be mapped to the corresponding vertical and horizontal beam indices i_{V,max} and i_{H,max} as

$${i}_{V , max} = {i}_{max} mod {M}_{V} , {i}_{H , max} = ⌊ \frac{{i}_{max}}{{M}_{V}} ⌋$$

where [x] denotes an integer smaller than or equal to x and mod is the modulo operator.

Using the vertical and horizontal beam indices, the M×1 precoding vector W_{i,max} may be constructed as

$${w}_{i , max} = \frac{1}{\sqrt{2}} [ \begin{matrix}1 \\ φ\end{matrix} ] ⊗ {b}_{{i}_{H , max}} ⊗ {b}_{{i}_{V , max}}$$

where b_{iH,max} is the i_{H,max} column of the matrix B_{H}, b_{iV,max} is the i_{V,max} column of the matrix B_{V}, and

$${φ}_{i} = {e}^{\sqrt{- 1} \frac{π κ}{2}}$$

is the co-phasing factor and κ ∈ {0,1,2,3}. In some embodiments, when PDCCH repetition is implemented, a configuration may apply a different co-phasing factor for the precoder used for each PDCCH transmission, e.g., in order to improve the robustness of the PDCCH transmission.

### PDCCH Link Adaptation

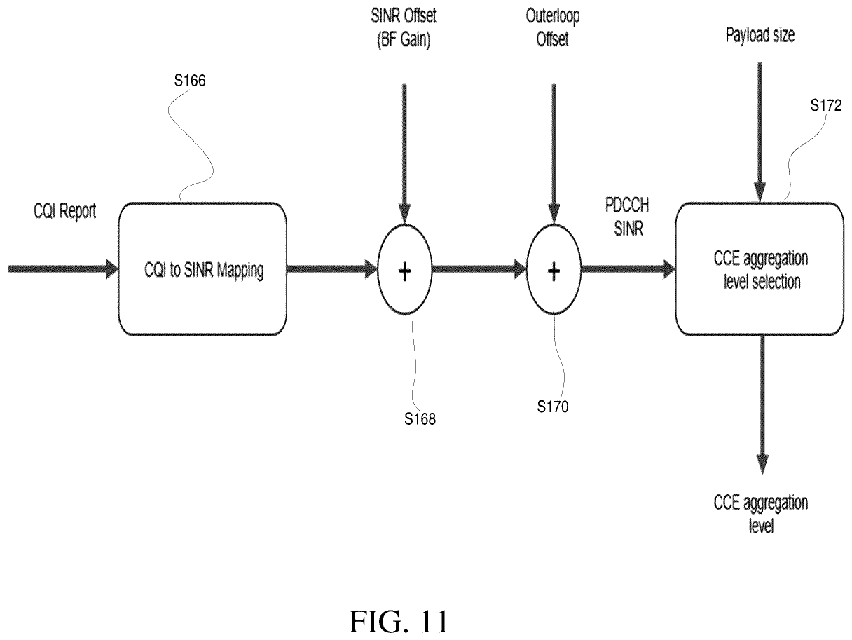

FIG. 11 shows a block diagram and process flow for an example PDCCH link adaptation algorithm according to some embodiments, where the reported Channel Quality Indicator (CQI) may be mapped to an SINR estimate (Step S166), which may be further modified by applying different offset values (Step S168 and Step S170) and used together with the PDCCH payload size to determine the PDCCH CCE aggregation level (Step S172). The beamforming gain of the PDCCH precoder may be added as one of the offset values of the SINR (i.e., Step S168). For the reciprocity-based precoder, in order to compute (e.g., by network node 16 and/or WD 22) the beamforming gain, network node 16 and/or WD 22 may approximate the M X M Beamspace covariance matrix of the WD 22 using the filtered normalized power per beam of the WD 22, e.g., as

$$\overline{R} = diag \{ {\overline{p}}_{0} , {\overline{p}}_{1} , … , {\overline{p}}_{M - 1} \}$$

The normalized beamforming gain (in dB) of the precoder w may be computed using the Beamspace covariance matrix of the WD 22 as

$$BF ( w ) = 10 {log}_{10} ( M {w}^{H} {B}^{H} \overline{R} B w )$$

where the precoder w may be transformed to Beamspace to match the Beamspace basis used for the covariance matrix approximation R̅. Thus, in at least some embodiments, BF (W_{i,max})=M_{pimax,av}.

The PDCCH SINR offset due to the beamforming gain of the Beamspace reciprocity based UBF precoder may be calculated (Step S170) (e.g., by network node 16 and/or WD 22) as

$${Offset}_{BF} = BF ( {w}_{i , max} ) - BF ( {w}_{0} )$$

where w₀ is the reported precoder that was used in calculating the reported CQI by the WD 22.

Some non-limiting embodiments of the present disclosure may be described according to the following examples, e.g., implemented in a network node 16 and WD 22:
Example 1. A system and method for PDCCH precoding fallback to reciprocity-based precoding before resorting to common beamforming when the wrong PDCCH precoder issue is detected.
Example 2. The reciprocity based precoder of Example 1, where the precoder is constructed by identifying the strongest channel directions in the azimuth-elevation directions using the filtered power per beam collected from Beamspace uplink channel estimates.
Example 3. The system and method of any of Examples 1 and 2, where the precoder is constructed by co-phasing the strongest channel directions and the co-phasing factor is variable when PDCCH repetition is implemented.
Example 4. The system and method of any of Examples 1-3, where the beamforming gain of the reciprocity based precoder is calculated using the filtered power per beam and used to update the SINR estimates for PDCCH link adaptation and CCE aggregation level selection.
Example 5. The system and method of any of Examples 1~4 where the wrong PDCCH precoder is detected using the time since last successfully decoded CSI report, the number of CSI DTX events, and/or the number of consecutive UL (and/or DL) HARQ DTX events.
Example 6. The system and method of any of Examples 1-5, in which switching between different types of precoding occurs based on the CCE aggregation level and according to the following orders: 1.1) Reciprocity based UBF, 1.2) using the PMI precoder that resulted in successful PDCCH reception, and 1.3) WD 22 independent CBF. 2.1) Using the PMI precoder that resulted in successful PDCCH reception, 2.2) reciprocity based UBF, and 2.3) WD 22 independent CBF.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

### Abbreviations that May be Used in the Preceding Description Include

2D-SDFT Two-Dimensional Spatial Discrete Fourier Transform
BBU BaseBand Unit
CBF Common Beamforming
CCE Control Channel Element
CSI Channel State Information
CSI-RS Channel State Information Reference Symbols
CQI Channel Quality Ii-8ndicator
DCI Downlink Control Information
DMRS Demodulation Reference Symbols
DL Downlink
DTX Discontinuous Transmission
HARQ Hybrid Automatic Repeat Request
PDCCH Physical Downlink Control Channel
PMI Precoding Matrix Indicator
RU Radio Unit
SINR Signal to Interference-plus-Noise Ratio
SNR Signal to Noise Ratio
UBF User-specific Beamforming
UE User Equipment
UL Uplink

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a WD in a wireless communication system, the network node comprising processing circuitry configured to:
detect a first beamforming precoder failure associated with a first beamforming precoder used for at least one downlink transmission to the WD;
responsive to detecting the first beamforming precoder failure, determine a first fallback beamforming configuration for the WD based on at least one of uplink reference signaling from the WD and a control channel element aggregation level associated with the WD;
configure the WD with the first fallback beamforming configuration; and
cause a first downlink transmission to the WD according to the first fallback beamforming configuration.

2. The network node of claim 1, wherein the determining of the first fallback beamforming configuration includes:
determining beam power information for a plurality of beams based on the uplink reference signaling;
determining at least one strongest channel direction for the plurality of beams based on the beam power information; and
determining a reciprocity-based precoder based on the at least one strongest channel direction.

3. The network node of claim 2, wherein the reciprocity-based precoder is associated with a plurality of different co-phasing factors, each of the plurality of co-phasing factors being configured for a corresponding downlink transmission of a plurality of downlink transmissions to the WD which use the reciprocity-based precoder.

4. The network node of claim 2, wherein determining of the reciprocity-based precoder includes:
determining co-phase information for the at least one strongest channel direction using a co-phasing factor, the co-phasing factor being variable based on a downlink control channel repetition being configured.

5. The network node of claim 4, wherein the determining of the beam power information for the plurality of beams based on the uplink reference signaling includes determining a polarization-averaged filtered power per beam of the plurality of beams.

6. The network node of claim 2, wherein the processing circuitry is further configured to:
determine a beamforming gain of the reciprocity-based precoder based on the beam power information;
determine a signal to interference and noise ratio estimate for downlink control channel link adaptation based on the beamforming gain; and
configure a control channel element aggregation level for the first downlink transmission to the WD based on at least one of the beamforming gain and the SINR estimate.

7. The network node of claim 1, wherein detecting the first beamforming precoder failure is based on at least one of:
an amount of time elapsed from a previously successfully decoded channel state information report exceeding a first threshold;
a number of CSI discontinuous transmission events exceeding a second threshold;
a number of consecutive uplink hybrid automatic repeat request DTX events exceeding a third threshold; and
a number of consecutive downlink HARQ DTX events exceeding a fourth threshold.

8. The network node of claim 1, wherein the first fallback beamforming configuration is one of:
a reciprocity-based precoder based on the CCE aggregation level being one; and
a most-recent previous successful precoder associated with the WD based on the CCE aggregation level being greater than one.

9. The network node of claim 8, wherein the processing circuitry is further configured to:
detect a second beamforming precoder failure associated with the first fallback beamforming configuration;
responsive to detecting the second beamforming precoder failure, determine a second fallback beamforming configuration, the second fallback beamforming configuration being one of:
a most-recent previous successful precoder associated with the WD based on the CCE aggregation level being one; and
a reciprocity-based precoder based on the CCE aggregation level being greater than one;
configure the WD with the second fallback beamforming configuration; and
cause transmission of a second downlink transmission to the WD according to the second fallback beamforming configuration.

10. The network node of claim 9, wherein the processing circuitry is further configured to:
detect a third beamforming precoder failure associated with the second fallback beamforming configuration;
responsive to detecting the third beamforming precoder failure, configure the WD with a third fallback beamforming configuration based on a common beamforming precoder; and
cause transmission of a third downlink transmission to the WD according to a third fallback beamforming configuration.

11. A method implemented in a network node configured to communicate with a WD in a wireless communication system, the method comprising:
detecting a first beamforming precoder failure associated with a first beamforming precoder used for at least one downlink transmission to the WD;
responsive to detecting the first beamforming precoder failure, determining a first fallback beamforming configuration for the WD based on at least one of uplink reference signaling from the WD and a control channel element aggregation level associated with the WD;
configuring the WD with the first fallback beamforming configuration; and
transmitting a first downlink transmission to the WD according to the first fallback beamforming configuration.

12-20. (canceled)

21. A WD configured to communicate with a network node in a wireless communication system, the WD comprising processing circuitry configured to:
cause transmission of a first uplink transmission to the network node, the first uplink transmission enabling the network node to detect a first beamforming precoder failure associated with a first beamforming precoder used for at least one downlink transmission to the WD;
responsive to the first uplink transmission, receive a first fallback beamforming configuration from the network node, the first fallback beamforming configuration being based on at least one of uplink reference signaling transmitted to the network node and a control channel element aggregation level associated with the WD;
receive a first downlink transmission from the network node; and
process the first downlink transmission according to the first fallback beamforming configuration.

22. The WD of claim 21, wherein the first fallback beamforming configuration includes a reciprocity-based precoder, the reciprocity-based precoder being selected based on beam power information for a plurality of beams associated with the uplink reference signaling, the beam power information including at least one strongest channel direction for the plurality of beams.

23. The WD of claim 22, wherein the reciprocity-based precoder is associated with a plurality of different co-phasing factors, each of the plurality of co-phasing factors being configured for a corresponding downlink transmission of a plurality of downlink transmissions to the WD which use the reciprocity-based precoder.

24. The WD of claim 22, wherein the reciprocity-based precoder is associated with co-phase information for the at least one strongest channel direction, the co-phase information including at least one co-phasing factor, the at least one co-phasing factor being variable based on a downlink control channel repetition being configured.

25. The WD of claim 24, wherein the beam power information for the plurality of beams is associated with a polarization-averaged filtered power per beam of the plurality of beams.

26. The WD of claim 21, wherein the first beamforming precoder failure is associated with at least one of:
an amount of time elapsed from a previously successfully decoded channel state information report exceeding a first threshold;
a number of CSI discontinuous transmission events exceeding a second threshold;
a number of consecutive uplink hybrid automatic repeat request DTX events exceeding a third threshold; and
a number of consecutive downlink HARQ DTX events exceeding a fourth threshold.

27. The WD claim 21, wherein the first fallback beamforming configuration is one of:
a reciprocity-based precoder based on the CCE aggregation level being one; and
a most-recent previous successful precoder associated with the WD based on the CCE aggregation level being greater than one.

28. The WD of claim 27, wherein the processing circuitry is further configured to:
cause transmission of a second uplink transmission to the network node, the second uplink transmission enabling the network node to detect a second beamforming precoder failure associated with the first fallback beamforming configuration;
responsive to the detecting of the second beamforming precoder failure, receive a second fallback beamforming configuration from the network node, the second fallback beamforming configuration being one of:
a most-recent previous successful precoder associated with the WD based on the CCE aggregation level being one; and
a reciprocity-based precoder based on the CCE aggregation level being greater than one;
receive a second downlink transmission from the network node; and
process the second downlink transmission according to the second fallback beamforming configuration.

29. The WD of claim 28, wherein the processing circuitry is further configured to:
cause transmission of a third uplink transmission to the network node, the third uplink transmission enabling the network node to detect a third beamforming precoder failure associated with the second fallback beamforming configuration;
receive a third fallback beamforming configuration from the network node, the third fallback beamforming configuration configuring beamforming based on a common beamforming precoder;
responsive to detecting the third beamforming precoder failure, receive a third downlink transmission from the network node; and
process the third downlink transmission according to the third fallback beamforming configuration.

30-38. (canceled)
